(19) United States
(12) Patent Application Publication
(10) Pub. No.: US 2026/0090493 A1
(43) Pub. Date: Apr. 2, 2026

(54) ELECTRIC WORK MACHINE

(71) Applicant: MAKITA CORPORATION, Anjo-shi (JP)

(72) Inventors: Hiroaki MATSUNAMI, Anjo-shi (JP); Itsuku KATO, Anjo-shi (JP); Masatoshi ITO, Anjo-shi (JP)

(73) Assignee: MAKITA CORPORATION, Anjo-shi (JP)

(21) Appl. No.: 19/343,772

(22) Filed: Sep. 29, 2025

(30) Foreign Application Priority Data
Sep. 30, 2024 (JP) 2024-170740

(51) Int. Cl. A01D 34/00; A01D 34/68; A01D 34/90; H02P 1/22

(52) U.S. Cl. CPC A01D 34/006; A01D 34/6818; A01D 34/90; H02P 1/22

(57) ABSTRACT

An electric work machine includes a motor, a drive switch, and a controller. The controller is configured to increase a magnitude of a voltage to be applied to the motor, based on the drive switch being turned on. The controller is configured to reduce the increase in the magnitude of the voltage to be applied, based on an actual rotational speed of the motor having reached a rotation threshold that has been set.

### CROSS-REFERENCE TO RELATED APPLICATIONS

This application claims the benefit of Japanese Patent Application No. 2024-170740 filed on Sep. 30, 2024 with the Japan Patent Office, the disclosure of which is incorporated herein by reference.

### BACKGROUND

The present disclosure relates to an electric work machine including a motor.

A grass cutter described in Japanese Unexamined Patent Application Publication No. 2018-57327 is provided with a cutting blade or a nylon cord, which is rotated with a power of a motor, attached to an end of the grass cutter. The motor of this grass cutter is configured such that, when a trigger switch is turned on from off, the actual rotational speed gradually increases up to a desired rotational speed.

### SUMMARY

The inertia of the grass cutter with the nylon cord attached thereto is smaller than the inertia of the grass cutter with the cutting blade attached thereto. Thus, if an increase in a start-up period of the motor in the case where the cutting blade is attached to the grass cutter is reduced, overshooting of the rotational speed may occur during the start-up of the motor in the case where the nylon cord is attached to the grass cutter. Moreover, if such overshooting of the rotational speed during the start-up of the motor in the case where the nylon cord is attached to the grass cutter is suppressed, the start-up period of the motor in the case where the cutting blade is attached to the grass cutter may increase.

It is desirable that one aspect of the present disclosure be capable of suppressing overshooting of the rotational speed of the motor while reducing variation in the start-up period of the motor caused by a difference in inertia between tip tools.

An electric work machine in one aspect of the present disclosure includes a motor, a drive switch, and a controller. The motor is configured to generate a driving force for rotating a tip tool. The drive switch is configured to be operated by a user to drive the motor. The controller is configured to: increase a magnitude of a voltage to be applied to the motor, based on the drive switch being turned on; reduce an increase in the magnitude of the voltage to be applied, based on an actual rotational speed of the motor having reached a rotation threshold that has been set; and commence a constant rotation control of the motor before the actual rotational speed reaches a desired rotational speed, thus maintaining the actual rotational speed at the desired rotational speed, the desired rotational speed being greater than the rotation threshold.

In this electric work machine, the increase rate of the magnitude of the voltage to be applied is reduced when the actual rotational speed reaches the rotation threshold. In a case where the inertia of the electric work machine is relatively small, the increase in the magnitude of the voltage to be applied is reduced relatively early, thus suppressing overshooting of the actual rotational speed. In a case where the inertia of the electric work machine is relatively large, the increase in the magnitude of the voltage to be applied is reduced relatively late, thus reducing an increase in the start-up period. Accordingly, overshooting of the actual rotational speed can be suppressed while reducing variation in the start-up period due to a difference in inertia of the electric work machine.

A method for controlling a motor of an electric work machine in another aspect of the present disclosure includes: increasing a magnitude of a voltage to be applied to the motor, based on a drive switch of the electric work machine being turned on; reducing an increase in the magnitude of the voltage to be applied, based on an actual rotational speed of the motor having reached a rotation threshold that has been set; and commencing a constant rotation control of the motor before the actual rotational speed reaches a desired rotational speed, thus maintaining the actual rotational speed at the desired rotational speed, the desired rotational speed being greater than the rotation threshold.

This method produces effects similar to those of the electric work machine described above.

### BRIEF DESCRIPTION OF THE DRAWINGS

Example embodiments of the present disclosure will be described hereinafter with reference to the accompanying drawings, in which:

FIG. 1A is a view showing one example of an external appearance of an electric work machine of a first embodiment;

FIG. 1B is a view showing another example of an external appearance of the electric work machine of the first embodiment;

FIG. 2 is a view showing an operation/display unit of the electric work machine of the first embodiment;

FIG. 3 is a diagram showing an electrical configuration of the electric work machine of the first embodiment;

FIG. 4 is a flowchart showing a main process performed by a control circuit of the electric work machine of the first embodiment;

FIG. 5 is a flowchart showing a motor control process performed by the control circuit of the electric work machine of the first embodiment;

FIG. 6 is a flowchart showing an output duty ratio setting process performed by the control circuit of the electric work machine of the first embodiment;

FIG. 7A is a table showing a correspondence relationship between drive modes and values related to a rotational speed in the electric work machine of the first embodiment;

FIG. 7B is a table showing a correspondence relationship between the drive modes and values related to a duty ratio in the electric work machine of the first embodiment;

FIG. 8 is a flowchart showing a desired duty ratio setting process performed by the control circuit of the electric work machine of the first embodiment;

FIG. 9 is a flowchart showing a rotation threshold setting process performed by the control circuit of the electric work machine of the first embodiment;

FIG. 10 is a flowchart showing a constant duty ratio control process performed by the control circuit of the electric work machine of the first embodiment;

FIG. 11 is a flowchart showing a constant rotation control process performed by the control circuit of the electric work machine of the first embodiment;

FIG. 12 is a flowchart showing an initial duty ratio setting process performed by the control circuit of the electric work machine of the first embodiment;

FIG. 13 is a flowchart showing a desired rotational speed setting process performed by the control circuit of the electric work machine of the first embodiment;

FIG. 14 is a diagram showing time variation of an actual rotational speed and an output duty ratio of each of the electric work machine with small inertia and the electric work machine with large inertia of the first embodiment;

FIG. 15 is a diagram showing time variation of an actual rotational speed and an output duty ratio of each of an electric work machine with small inertia and an electric work machine with large inertia of a reference example;

FIG. 16 is a diagram showing time variation of an actual rotational speed and an output duty ratio of each of an electric work machine with small inertia and an electric work machine with large inertia of another reference example;

FIG. 17 is a flowchart showing an output duty ratio setting process performed by a control circuit of an electric work machine of a second embodiment;

FIG. 18 is a diagram showing time variation of an actual rotational speed and an output duty ratio of each of the electric work machine with small inertia and the electric work machine with large inertia of the second embodiment;

FIG. 19 is a flowchart showing an output duty ratio setting process performed by a control circuit of an electric work machine of a third embodiment;

FIG. 20 is a flowchart showing a fixed duty ratio setting process performed by the control circuit of the electric work machine of the third embodiment; and

FIG. 21 is a diagram showing time variation of an actual rotational speed and an output duty ratio of each of the electric work machine with small inertia and the electric work machine with large inertia of the third embodiment.

### DETAILED DESCRIPTION OF EXEMPLARY EMBODIMENTS

### Overview of Embodiments

One embodiment may provide an electric work machine including at least any one of the following features:
Feature 1: A motor configured to generate a driving force for rotating a tip tool.
Feature 2: A drive switch configured to be operated by a user to drive the motor.
Feature 3: a Controller.
Feature 4: The controller is configured to increase a magnitude of a voltage to be applied to the motor, based on the drive switch being turned on.
Feature 5: The controller is configured to reduce an increase in the magnitude of the voltage to be applied, based on an actual rotational speed of the motor having reached a rotation threshold that has been set.
Feature 6: The controller is configured to commence a constant rotation control of the motor before the actual rotational speed reaches a desired rotational speed, thus maintaining the actual rotational speed at the desired rotational speed.
Feature 7: The desired rotational speed is greater than the rotation threshold.

In the electric work machine including at least the features 1 through 7, the increase in the magnitude of the voltage to be applied is reduced when the actual rotational speed reaches the rotation threshold. In a case where the inertia of the electric work machine is relatively small, the increase in the magnitude of the voltage to be applied is reduced relatively early, thus suppressing overshooting of the actual rotational speed. In a case where the inertia of the electric work machine is relatively large, the increase in the magnitude of the voltage to be applied is reduced relatively late, thus reducing an increase in the start-up period. Accordingly, overshooting of the actual rotational speed can be suppressed while reducing variation in the start-up period due to a difference in inertia of the electric work machine.

One embodiment may include at least any one of the following features in addition to or in place of at least any one of the features 1 through 7 described above.
Feature 8: The controller is configured to increase the magnitude of the voltage to be applied at a first increase rate, based on the drive switch being turned on.
Feature 9: The controller is configured to change the first increase rate to a second increase rate based on the actual rotational speed having reached the rotation threshold.
Feature 10: The second increase rate is less than the first increase rate.

In the electric work machine including at least the features 1 through 10, in the case where the inertia of the electric work machine is relatively small, the increase in the magnitude of the voltage to be applied can be reduced relatively early. In contrast, in the case where the inertia of the electric work machine is relatively large, the increase in the magnitude of the voltage to be applied can be reduced relatively late.

One embodiment may include at least any one of the following features in addition to or in place of at least any one of the features 1 through 7 described above.
Feature 11: The controller is configured to increase the magnitude of the voltage to be applied at a specified increase rate, based on the drive switch being turned on.
Feature 12: The controller is configured to fix the magnitude of the voltage to be applied at a specified value, based on the actual rotational speed having reached the rotation threshold.
Feature 13: The specified value is equal to or less than a magnitude of an applied voltage at a time point when the actual rotational speed reaches the rotation threshold.

In the electric work machine including at least the features 1 through 7 and 11 through 13, in the case where the inertia of the electric work machine is relatively small, the increase in the magnitude of the voltage to be applied can be reduced relatively early. In contrast, in the case where the inertia of the electric work machine is relatively large, the increase in the magnitude of the voltage to be applied can be reduced relatively late.

One embodiment may include the following features in addition to or in place of at least any one of the features 1 through 10 described above.
Feature 14: The second increase rate is zero.
Feature 15: The controller is configured to fix the magnitude of the voltage to be applied at a specified value during a period from when the actual rotational speed reaches the rotation threshold until the constant rotation control is commenced.
Feature 16: The specified value is a magnitude of an applied voltage at a time point when the actual rotational speed reaches the rotation threshold.

In the electric work machine including at least the features 1 through 10 and 14 through 16, the magnitude of the voltage to be applied is fixed at the value at the time point when the actual rotational speed reaches the rotation threshold. This makes the increase in the actual rotational speed moderate, thus enabling suppression of overshooting.

One embodiment may include at least any one of the following features in addition to or in place of at least any one of the features 1 through 16 described above.
Feature 17: A drive circuit configured to drive the motor.
Feature 18: The controller is configured to change the magnitude of the voltage to be applied, based on an output duty ratio of a pulse-width modulation signal to be output to the drive circuit.
Feature 19: The controller is configured to control the output duty ratio to be equal to or less than a desired duty ratio that has been set, during a period from when the drive switch is turned on until the constant rotation control is commenced.

In the electric work machine including at least the features 1 through 7 and the features 17 through 19, before the constant rotation control is commenced, the output duty ratio is controlled to be equal to or less than the desired duty ratio. This makes it possible to inhibit an abrupt increase in the actual rotational speed during the start-up period.

One embodiment may include at least any one of the following features in addition to or in place of at least any one of the features 1 through 19 described above.
Feature 20: The controller is configured to commence the constant rotation control based on the actual rotational speed having reached a commencement rotational speed.
Feature 21: The commencement rotational speed is greater than the rotation threshold and less than the desired rotational speed.

In the electric work machine including at least the features 1 through 7 and the features 20 through 21, the controller commences the constant rotation control before the actual rotational speed reaches the desired rotational speed. This makes it possible to suppress overshooting of the actual rotational speed.

One embodiment may include at least any one of the following features in addition to or in place of at least any one of the features 1 through 21 described above.
Feature 22: A drive mode of the motor includes a first mode and a second mode.
Feature 23: A selector switch configured to be operated by the user to select the first mode or the second mode.
Feature 24: The controller is configured to set a first threshold for the rotation threshold based on the first mode being selected via the selector switch.
Feature 25: The controller is configured to set a second threshold for the rotation threshold based on the second mode being selected via the selector switch, the second threshold being different from the first threshold.

In the electric work machine including at least the features 1 through 7 and the features 22 through 25, the controller changes the rotation threshold according to the drive mode. This makes it possible to suppress overshooting of the actual rotational speed while reducing variation in the start-up period due to the difference in the drive mode.

One embodiment may include at least any one of the following features in addition to or in place of at least any one of the features 1 through 25 described above.
Feature 26: The controller is configured to set a first duty ratio for the desired duty ratio based on the first mode being selected via the selector switch.
Feature 27: The controller is configured to set a second duty ratio for the desired duty ratio based on the second mode being selected via the selector switch, the second duty ratio being different from the first duty ratio.

In the electric work machine including at least the features 1 through 7 and the features 17 through 19, 22 through 23, and 26 through 27, the controller changes the desired duty ratio according to the drive mode. This makes it possible to suppress overshooting of the actual rotational speed while reducing variation in the start-up period due to the difference in the drive mode.

One embodiment may include at least any one of the following features in addition to or in place of at least any one of the features 1 through 27 described above.
Feature 28: The controller is configured to set a third threshold for the rotation threshold based on the motor rotating in a forward direction.
Feature 29: The controller is configured to set a fourth threshold for the rotation threshold based on the motor rotating in a direction opposite to the forward direction, the fourth threshold being different from the third threshold.

In the electric work machine including at least the features 1 through 7 and the features 28 through 29, the controller changes the rotation threshold according to the direction of rotation of the motor. This makes it possible to suppress overshooting of the actual rotational speed while reducing variation in the start-up period due to the difference in the direction of rotation.

One embodiment may include at least any one of the following features in addition to or in place of at least any one of the features 1 through 29 described above.
Feature 30: The controller is configured to set a third duty ratio for the desired duty ratio based on the motor rotating in a forward direction.
Feature 31: The controller is configured to set a fourth duty ratio for the desired duty ratio based on the motor rotating in a direction opposite to the forward direction, the fourth duty ratio being different from the third duty ratio.

In the electric work machine including at least the features 1 through 7 and the features 17 through 19 and 30 through 31, the controller changes the desired duty ratio according to the direction of rotation of the motor. This makes it possible to suppress overshooting of the actual rotational speed while reducing variation in the start-up period due to the difference in the direction of rotation.

One embodiment may provide a method for controlling a motor of an electric work machine, including at least any one of the following features:
Feature 32: Increasing a magnitude of a voltage to be applied to the motor, based on a drive switch of the electric work machine being turned on.
Feature 33: Reducing an increase in the magnitude of the voltage to be applied, based on an actual rotational speed of the motor having reached a rotation threshold that has been set.
Feature 34: Commencing a constant rotation control of the motor before the actual rotational speed reaches a desired rotational speed, thus maintaining the actual rotational speed at the desired rotational speed, the desired rotational speed being greater than the rotation threshold.

The method including at least the features 32 through 34 produces effects similar to those of the electric work machine including at least the features 1 through 7.

Examples of the above-described electric work machine include various work machines configured for use in work sites of architecture, manufacturing, horticulture, civil engineering, and so on, which are specifically electric power tools for masonry work, metalworking, and woodworking, work machines for gardening, and electric power tools for preparing an environment of job sites. Particularly, these examples of the electric work machine include electric power tools for masonry work, metalworking, and woodworking, and work machines for gardening, to which tip tools or attachments of two or more kinds can be attached. Examples of such electric power tools include a grass cutter to which two or more tip tools can be attached, a split grass cutter in which two or more attachments can be attached to its rod, and an electric hammer, an electric drill, an electric driver, an electric impact driver, and so on, to which two or more tip tools can be attached.

In one embodiment, the above-described features 1 through 34 may be combined in any combination.

In one embodiment, any of the above-described features 1 through 34 may be excluded.

### First Embodiment

### 1-1. Configuration

### 1-1-1. Overall Configuration

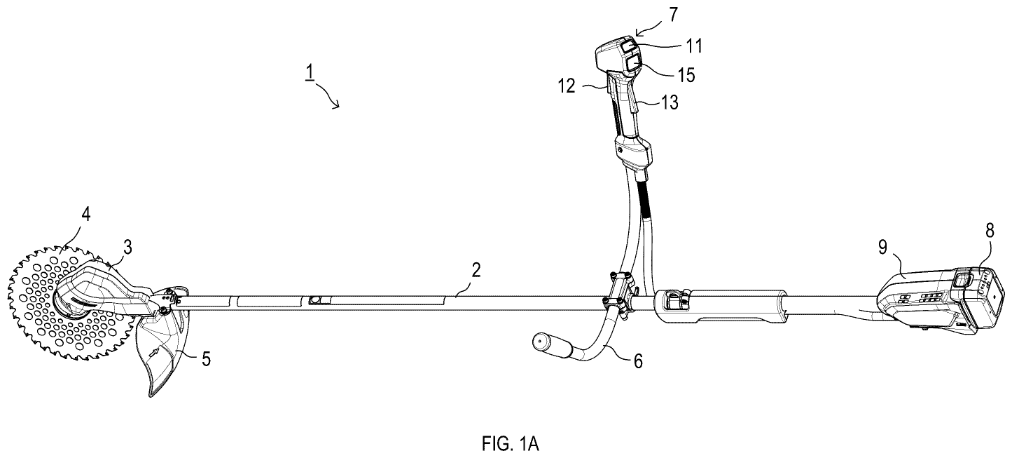

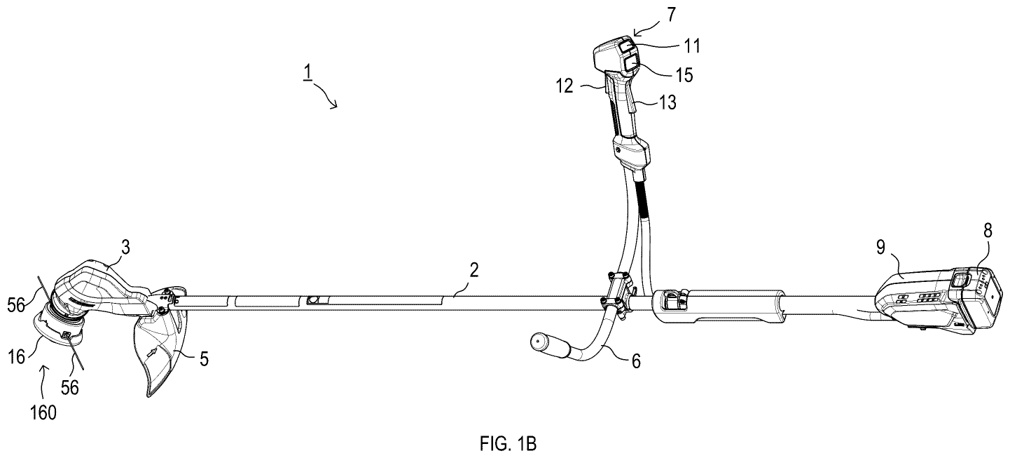

An electric work machine 1 of the present embodiment will be described with reference to FIGS. 1A and 1B. The electric work machine 1 of the present embodiment is a grass cutter, as an example. The electric work machine 1 includes a main pipe 2. The main pipe 2 has a first end and a second end, and is formed in an elongated and hollow rod-like shape.

The electric work machine 1 includes a drive unit 3. The drive unit 3 is attached to the first end of the main pipe 2. The drive unit 3 includes therein a motor 20 to be described below. The drive unit 3 includes a gear mechanism for deceleration at an end of a rotation shaft of the motor 20. A rotary blade 4 is detachably attached to an output shaft of the gear mechanism. The rotary blade 4 is one example of a tip tool. When the motor 20 rotates, the output shaft of the gear mechanism rotates integrally with the rotary blade 4. The rotary blade 4 is of metal and formed in a disc-like shape. The rotary blade 4 has serrated teeth formed along an outer periphery of a body thereof of the disc-like shape. The rotary blade 4 is rotated with a driving force of the motor 20 to thereby cut grass, branches, and the like.

As shown in FIG. 1B, in place of the rotary blade 4, a nylon cord cutter 160 may be detachably attached to the output shaft of the gear mechanism. The nylon cord cutter 160 is another example of the tip tool. The nylon cord cutter 160 includes a spool 16 of a cylindrical shape, and a nylon cord 56 housed in the spool 16. A side surface of the spool 16 contains two holes, and the nylon cord 56 is drawn out from these two holes. When the spool 16 is rotated with the driving force of the motor 20, the nylon cord 56 drawn out from the two holes hits the grass and the like to cut it.

The nylon cord cutter 160 is lighter than the rotary blade 4. Thus, the inertia of the electric work machine 1 with the nylon cord cutter 160 attached thereto is smaller than the inertia of the electric work machine 1 with the rotary blade 4 attached thereto. In other words, the inertia of the electric work machine 1 changes depending on the kind of the tip tool attached to the electric work machine 1.

The electric work machine 1 includes a cover 5. The cover 5 is attached to the first end of the main pipe 2. The cover 5 is attached to a portion closer to the second end relative to the rotary blade 4 or the nylon cord cutter 160. The cover 5 inhibits the grass and the like cut by the rotary blade 4 or the nylon cord cutter 160 from flying toward a user.

The electric work machine 1 includes a handle 6. The handle 6 is coupled to the main pipe 2 near a longitudinally intermediate position of the main pipe 2. The handle 6 is formed in a U-shape, and grips are attached to respective portions corresponding to two ends of the U-shape. The user grasps the two grips to work with the electric work machine 1.

The electric work machine 1 includes an operation/display unit 7. The operation/display unit 7 is arranged on one of the two grips of the handle 6. The operation/display unit 7 includes a display portion 11 and an operation portion 15. The details of the display portion 11 and the operation portion 15 will be described below. The operation/display unit 7 includes a trigger switch 12 and a lock-off switch 13.

The trigger switch 12 is operated by the user to drive the motor 20. Specifically, the user pulls the trigger switch 12 to drive the motor 20 when a main power is ON, and releases the trigger switch 12 to stop the motor 20. The trigger switch 12 outputs an ON-signal to a control circuit 33 to be described below while being pulled, and outputs an OFF-signal to the control circuit 33 while being released. In the present embodiment, the trigger switch 12 is one example of the drive switch described in Overview of Embodiments.

The lock-off switch 13 is operated by the user to enter a locked state or a released state. When the lock-off switch 13 is in the locked state, the user cannot pull the trigger switch 12. When the lock-off switch 13 is in the released state, the user can pull the trigger switch 12.

The electric work machine 1 includes a control unit 9. The control unit 9 is attached to the second end of the main pipe 2. The control unit 9 includes therein a controller 30 to be described below. The controller 30 is connected to the motor 20 via a harness running within the main pipe 2. Also, the controller 30 is connected to the operation/display unit 7 via a harness running within the main pipe 2. The control unit 9 is configured such that a battery pack 8 is detachably attached thereto. The battery pack 8 includes two or more battery cells connected in series. The battery pack 8 is a rechargeable battery, which can be charged and discharged, and is a lithium-ion battery, for example. The battery pack 8 supplies a direct-current power to the controller 30. The motor 20 and the operation/display unit 7 receives the direct-current power from the battery pack 8 via the controller 30.

### 1-1-2. Operation/Display Unit

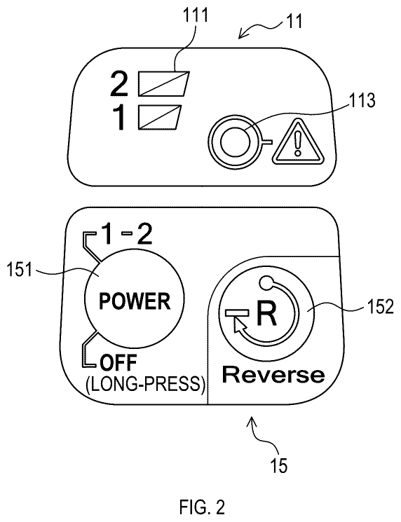

The display portion 11 and the operation portion 15 of the electric work machine 1 will be described with reference to FIG. 2. The operation portion 15 is operated by the user to cause the electric work machine 1 to operate. The operation portion 15 includes a main-power/mode selector switch 151 and a reverse-rotation switch 152. The main-power/mode selector switch 151 is a tactile switch and is operated by the user to turn on and off the main power or to select a normal mode. When the user long-presses the main-power/mode selector switch 151, the main power is turned from OFF to ON, or from ON to OFF. Long-pressing the switch corresponds to keeping the switch pressed for a given period or longer. When the user short-presses the main-power/mode selector switch 151, the normal mode changes. Short-pressing the switch corresponds to pressing the switch and releasing it before elapse of the given period. The main-power/mode selector switch 151 outputs an ON-signal to the control circuit 33 while being pressed, and outputs an OFF-signal to the control circuit 33 while being released.

In the present embodiment, a drive mode of the motor 20 includes the normal mode and a reverse-rotation mode to be described below. The normal mode includes a low-speed mode and a high-speed mode. The motor 20 rotates in a forward direction in the normal mode. Each time the user short-presses the main-power/mode selector switch 151, the drive mode changes in the order of the low-speed mode, the high-speed mode, and the low-speed mode. A desired (target) rotational speed ωt in the low-speed mode is less than the desired rotational speed ωt in the high-speed mode. The desired rotational speed ωt is a desired value of a rotational speed of the motor 20. In the present embodiment, the main-power/mode selector switch 151 corresponds to one example of the selector switch described in Overview of Embodiments, and the high-speed mode and the low-speed mode correspond to one example of the first mode and the second mode, respectively, described in Overview of Embodiments.

The reverse-rotation switch 152 is a tactile switch and is operated by the user to select the reverse-rotation mode. The motor 20 rotates in a direction opposite to the forward direction in the reverse-rotation mode. In a case where grass or the like gets entangled in the rotary blade 4 or the nylon cord cutter 160, the motor 20 is driven in the reverse-rotation mode to thereby separate the grass or the like from the rotary blade 4 or the nylon cord cutter 160.

When the user presses the reverse-rotation switch 152, the drive mode changes from the normal mode to the reverse-rotation mode. When the user presses the reverse-rotation switch 152 in the reverse-rotation mode, the drive mode changes from the reverse-rotation mode to the normal mode. After the motor 20 is started to be driven in the reverse-rotation mode, upon elapse of a given period (e.g., a few seconds), the motor 20 stops automatically. Then, the drive mode automatically changes from the reverse-rotation mode to the normal mode. Thus, when the user pulls the trigger switch 12 after the automatic stop of the motor 20, the motor 20 rotates in the forward direction. The reverse-rotation switch 152 outputs an ON-signal to the control circuit 33 while being pressed, and outputs an OFF-signal to the control circuit 33 while being released.

In other embodiments, the drive mode may include another mode, in addition to the low-speed mode, the high-speed mode, and the reverse-rotation mode.

The display portion 11 notifies the user of the drive mode that is set and a malfunction state. The display portion 11 includes a speed/reverse-rotation indicator 111 and a malfunction indicator 113. The speed/reverse-rotation indicator 111 includes two light emitting diodes (hereinafter referred to as LEDs) corresponding to the low-speed mode and the high-speed mode. When the low-speed mode is set, one of the two LEDs is turned on, and when the high-speed mode is set, the other of the two LEDs is turned on. When the reverse-rotation mode is set, the two LEDs blink. The malfunction indicator 113 includes one LED, and when a malfunction state is detected during operation of the electric work machine 1, the LED is blinked or turned on to notify the user of the malfunction state.

### 1-1-3. Electrical Configuration

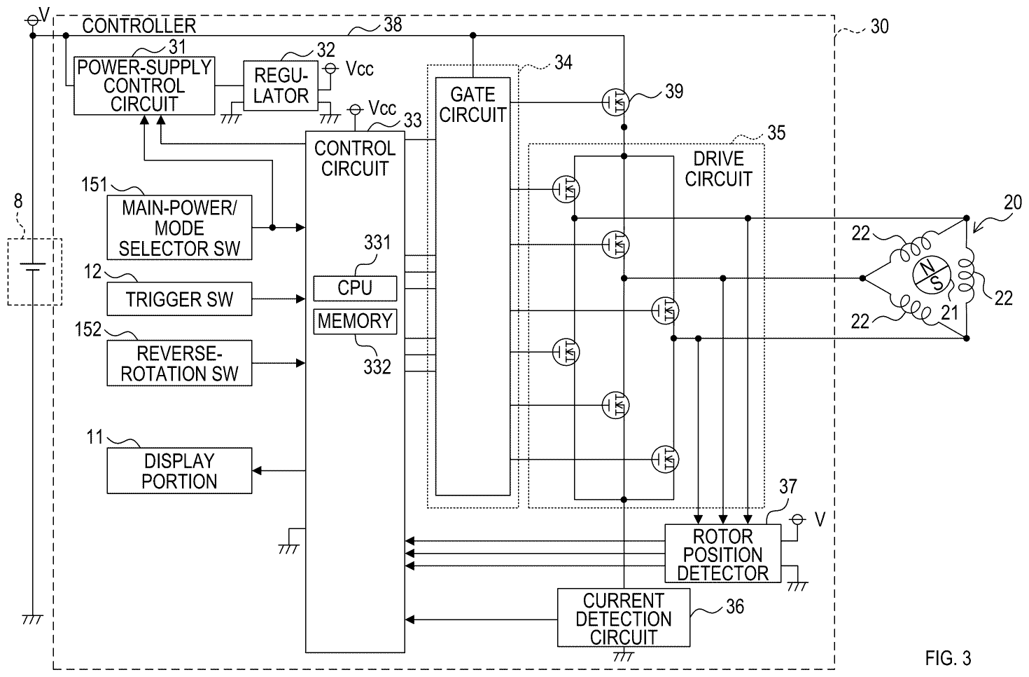

An electrical configuration of the electric work machine 1 will be described with reference to FIG. 3. The electric work machine 1 includes the motor 20. The motor 20 is a three-phase brushless motor. The motor 20 includes three-phase windings (i.e., a stator) 22 and a rotor 21. The motor 20 is a sensorless motor. In other embodiments, the motor 20 is not limited to the three-phase motor and may be a single-phase motor, a two-phase motor, or a polyphase motor with four or more phases. Alternatively, the motor 20 may be a brushed motor.

The electric work machine 1 includes the controller 30. The controller 30 includes a power-supply control circuit 31, a regulator 32, the control circuit 33, a gate circuit 34, a drive circuit 35, a current detection circuit 36, a rotor position detector 37, a power-supply line 38, and an interrupting switch 39.

When the main power is in an ON state, the power-supply control circuit 31 drives the regulator 32 to generate a power-supply voltage Vcc. The regulator 32 supplies the generated power-supply voltage Vcc to the control circuit 33 and so on.

The power-supply line 38 couples a positive electrode of the battery pack 8 to the drive circuit 35. The interrupting switch 39 is arranged on the power-supply line 38. When the interrupting switch 39 is in an ON state, the power-supply line 38 is completed, and electric power is supplied from the battery pack 8 to the drive circuit 35. When the interrupting switch 39 is in an OFF state, the power-supply line 38 is interrupted, and the electric power is not supplied from the battery pack 8 to the drive circuit 35.

The drive circuit 35 is a three-phase full-bridge circuit including three high-side switching elements and three low-side switching elements. The six switching elements are, for example, metal-oxide-semiconductor field-effect transistors (MOSFETs). ON/OFF of the six switching elements is controlled by the control circuit 33 via the gate circuit 34. The drive circuit 35 is controlled by the control circuit 33, thus applying a pulse-width modulated voltage to the windings 22 of the motor 20. In other embodiments, the six switching elements may be other FETs, insulated gate bipolar transistors (IGBTs), silicon-controlled rectifiers (SCRs), or the like.

The gate circuit 34 is coupled to the power-supply line 38 and turns the six switching elements of the drive circuit 35 on or off based on a control signal output from the control circuit 33. The control signal is a pulse-width modulation (PWM) signal and has an output duty ratio that has been set. Also, the gate circuit 34 turns the interrupting switch 39 on or off based on a command signal output from the control circuit 33. Specifically, the gate circuit 34 turns on the interrupting switch 39 when the control circuit 33 permits driving of the motor 20, and turns off the interrupting switch 39 when the control circuit 33 prohibits driving of the motor 20.

The current detection circuit 36 detects the magnitude of the current that has flown through the windings 22 of the motor 20, and outputs a current detection value corresponding to the magnitude of the current to the control circuit 33.

The rotor position detector 37 detects a zero-crossing point of an induced voltage generated in each of the windings 22, and outputs a detection signal of each phase to the control circuit 33.

The control circuit 33 includes a CPU 331 and a memory 332. The control circuit 33 calculates a rotational position of the rotor 21 based on the detection signal of each phase input from the rotor position detector 37. Also, the control circuit 33 calculates an actual rotational speed of the motor 20.

Moreover, the control circuit 33 generates the control signal based on the input various information, and outputs the generated control signal to the gate circuit 34. Specifically, the control circuit 33 generates the control signal based on (i) the ON-signal or the OFF-signal input from the trigger switch 12, the main-power/mode selector switch 151, and the reverse-rotation switch 152, (ii) the current detection value input from the current detection circuit 36, and (iii) the calculated rotational speed.

Furthermore, the control circuit 33 turns on, blinks, or turns off each LED in the display portion 11 based on the ON-signal or the OFF-signal input from the trigger switch 12, the main-power/mode selector switch 151, and the reverse-rotation switch 152. In the present embodiment, the control circuit 33 is one example of the controller described in Overview of Embodiments.

In other embodiments, at least one of the power-supply control circuit 31, the regulator 32, the control circuit 33, the gate circuit 34, the drive circuit 35, the current detection circuit 36, the rotor position detector 37, the power-supply line 38, or the interrupting switch 39 may be excluded from the controller 30.

### 1-2. Processes

### 1-2-1. Main Process

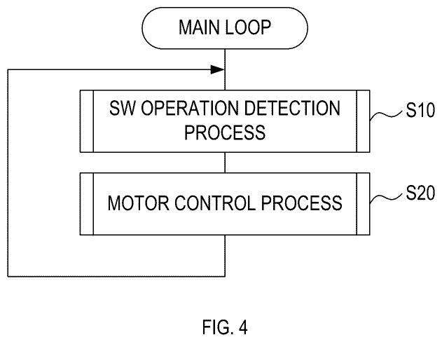

A main process performed by the control circuit 33 will be described with reference to a flowchart of FIG. 4. The control circuit 33 starts this process when the main power is turned on from off and repeatedly performs this process at a given cycle.

In S10, the control circuit 33 performs a switch operation detection process. Specifically, the control circuit 33 obtains the ON-signal or the OFF-signal from each of the trigger switch 12, the main-power/mode selector switch 151, and the reverse-rotation switch 152.

Then, in S20, the control circuit 33 performs a motor control process, thus controlling driving of the motor 20. The details of the motor control process will be described below.

### 1-2-2. Motor Control Process

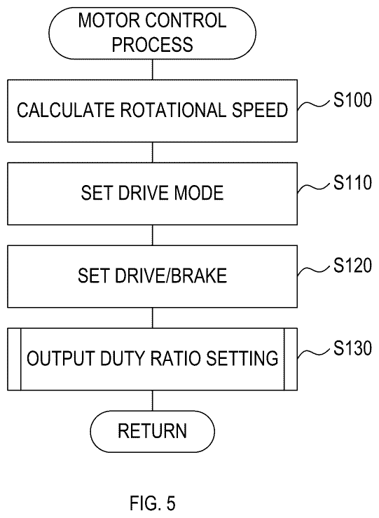

The motor control process performed by the control circuit 33 in S20 of the main process will be described with reference to a flowchart of FIG. 5.

In S100, the control circuit 33 obtains the detection signal of each phase from the rotor position detector 37 and calculates the actual rotational speed of the motor 20.

Then, in S110, the control circuit 33 sets the drive mode based on the ON-signal or the OFF-signal obtained from each of the main-power/mode selector switch 151 and the reverse-rotation switch 152. Specifically, the control circuit 33 sets any of the low-speed mode, the high-speed mode, and the reverse-rotation mode for the drive mode.

Next, in S120, the control circuit 33 sets a drive permission or sets a brake operation to be active. Specifically, the control circuit 33 sets the drive permission when the trigger switch 12 is turned on from off, and the control circuit 33 sets the brake operation to be active when the trigger switch 12 is turned off from on or when any malfunction is detected.

Subsequently, in S130, the control circuit 33 performs an output duty ratio setting process, thus setting the output duty ratio of the PWM signal to be output to the gate circuit 34. In other words, the control circuit 33 sets the duty ratio of the voltage to be applied to the windings 22 of the motor 20. The details of the output duty ratio setting process will be described below.

### 1-2-3. Output Duty Ratio Setting Process

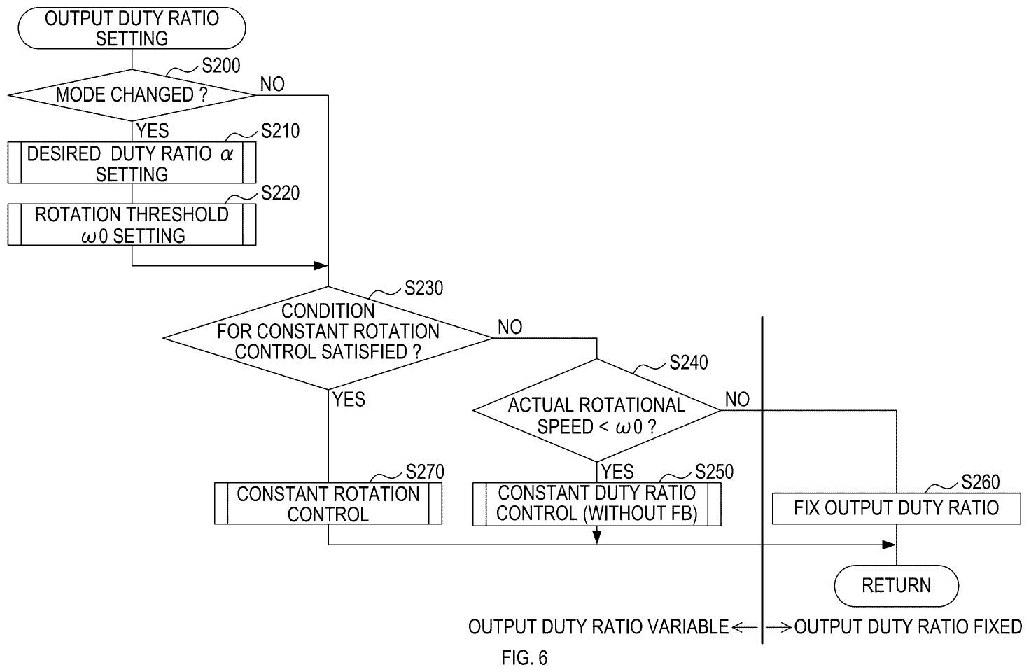

The output duty ratio setting process performed by the control circuit 33 in S130 of the motor control process will be described with reference to a flowchart of FIG. 6.

In S200, the control circuit 33 determines whether the set drive mode has changed from the drive mode at the previous process cycle. Upon determining that the drive mode has changed (S200: YES), the control circuit 33 proceeds to a process of S210. Upon determining that the drive mode has not changed (S200: NO), the control circuit 33 proceeds to a process of S230.

In S210, the control circuit 33 performs a desired duty ratio α setting process, thus setting a desired duty ratio α according to the drive mode. The desired duty ratio α is a desired value of the output duty ratio in a start-up period of the motor 20. In the start-up period, the control circuit 33 gradually increases the output duty ratio within a range of the desired duty ratio α or less. After the start-up period, the control circuit 33 performs a constant rotation control. The start-up period is a period from a time point when the motor 20 is started to be driven to a reaching time point. The time point when the motor 20 is started to be driven corresponds to a time point when the trigger switch 12 is turned on from off. The reaching time point corresponds to a time point when the actual rotational speed reaches a commencement rotational speed ωc. The commencement rotational speed ωc is a speed at which the constant rotation control is to be commenced, and is less than the desired rotational speed ωt. The details of the desired duty ratio α setting process will be described below.

Then, in S220, the control circuit 33 performs a rotation threshold ω0 setting process, thus setting a rotation threshold ω0 according to the drive mode. The rotation threshold ω0 is a value less than the commencement rotational speed ωc. The rotation threshold ω0 is a threshold for changing the increase rate of the output duty ratio in the start-up period. The inertia of the electric work machine 1 varies depending on the kind of the tip tool. In a case where the inertia of the electric work machine 1 is relatively small, if the output duty ratio continues to be increased at a constant increase rate until the actual rotational speed reaches the commencement rotational speed ωc, overshooting of the actual rotational speed may occur. If the increase rate of the output duty ratio is reduced, the overshooting of the actual rotational speed can be suppressed. However, in a case where the inertia of the electric work machine 1 is relatively large, if the increase rate of the output duty ratio is reduced, the start-up period may increase. This, in turn, may impair the usability of users.

To cope with this, in the present embodiment, the control circuit 33 reduces the increase rate of the output duty ratio at a time point when the actual rotational speed reaches the rotation threshold ω0 during the start-up period. In the case where the inertia of the electric work machine 1 is relatively small, the actual rotational speed reaches the rotation threshold ω0 relatively early. Accordingly, the increase rate of the output duty ratio is reduced relatively early, thus suppressing the overshooting of the actual rotational speed. In the case where the inertia of the electric work machine 1 is relatively large, the actual rotational speed reaches the rotation threshold ω0 relatively late. Accordingly, the increase rate of the output duty ratio is reduced relatively late, thus reducing an increase in the start-up period. The details of the rotation threshold ω0 setting process will be described below.

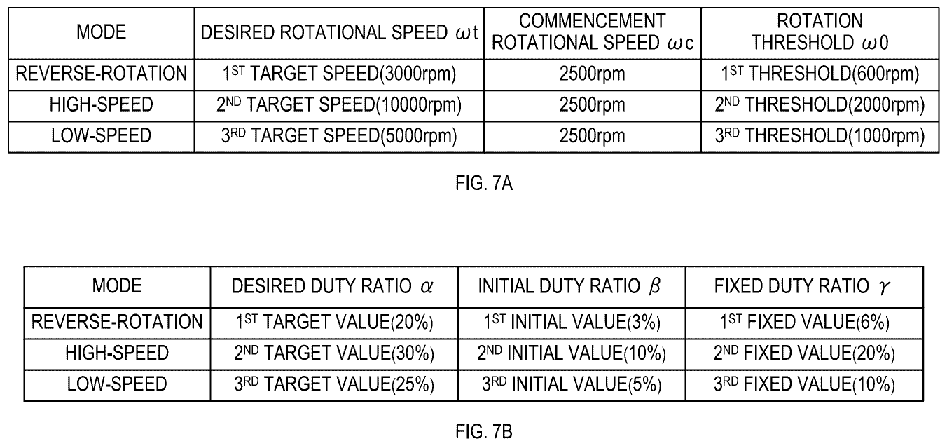

In S230, the control circuit 33 determines whether a condition for the constant rotation control is satisfied. The condition for the constant rotation control is satisfied based on the actual rotational speed exceeding the commencement rotational speed ωc. As shown in FIG. 7A, the commencement rotational speed ωc is set to a constant value regardless of the drive mode. The commencement rotational speed ωc is, for example, 2,500 rpm. When the constant rotation control is commenced after the actual rotational speed reaches the desired rotational speed ωt, the actual rotational speed may exceed the desired rotational speed ωt. Thus, the control circuit 33 commences the constant rotation control before the actual rotational speed reaches the desired rotational speed ωt.

On the other hand, in order to perform the constant rotation control with high accuracy, an accurate actual rotational speed is required. As described above, in the sensorless motor, the rotational position of the rotor 21 is calculated based on the zero-crossing of the induced voltage generated in each of the windings 22. The induced voltage is proportional to the actual rotational speed of the motor 20. Thus, when the actual rotational speed of the motor 20 is low, the detection accuracy of the zero-crossing decreases. This, in turn, decreases the calculation accuracy of the rotational position of the rotor 21, thus decreasing the calculation accuracy of the actual rotational speed. Accordingly, it is desirable that the control circuit 33 commence the constant rotation control after the actual rotational speed has increased to a level at which the detection accuracy of the zero-crossing is stabilized.

In a case where the motor 20 is a sensor-equipped motor, too, the control circuit 33 may commence the constant rotation control after the actual rotational speed has increased to the level at which the detection accuracy of the zero-crossing is stabilized. When detecting the rotational position of the rotor 21 with a three-phase Hall sensor, if the rotational speed is too low, a time interval at which signals are output from the Hall sensor becomes longer. This, in turn, decreases the frequency at which the control circuit 33 calculates the actual rotational speed, which may lead to a decrease in the accuracy of the constant rotation control.

Upon determining that the condition for the constant rotation control is satisfied (S230: YES), the control circuit 33 proceeds to a process of S270. Upon determining that the condition for the constant rotation control is not satisfied (S230: NO), the control circuit 33 proceeds to a process of S240.

In S240, the control circuit 33 determines whether the actual rotational speed is less than the rotation threshold ω0 set in S220. Upon determining that the actual rotational speed is less than the rotation threshold ω0 (S240: YES), the control circuit 33 proceeds to a process of S250. Upon determining that the actual rotational speed is equal to or greater than the rotation threshold ω0 (S240: NO), the control circuit 33 proceeds to a process of S260.

In S250, the control circuit 33 performs a constant duty ratio control process and increases the output duty ratio at a first increase rate. A constant duty ratio control is a control without feedback. Then, the control circuit 33 terminates this process. The details of the constant duty ratio control process will be described below.

In S260, the control circuit 33 reduces the increase rate of the output duty ratio to zero and sets a fixed value for the output duty ratio. The fixed value is the output duty ratio at the time point when the actual rotational speed reaches the rotation threshold ω0, and is equal to or less than the desired duty ratio α. The control circuit 33 outputs a PWM signal having the fixed value to the gate circuit 34. In other words, the control circuit 33 fixes the magnitude of a voltage to be applied to the windings 22 at the value of an applied voltage at the time point when the actual rotational speed reaches the rotation threshold ω0. Then, the control circuit 33 terminates this process.

In S270, the control circuit 33 performs the constant rotation control and maintains the actual rotational speed at the desired rotational speed ωt. Then, the control circuit 33 terminates this process. The details of the constant rotation control will be described below.

### 1-2-4. Desired Duty Ratio Setting Process

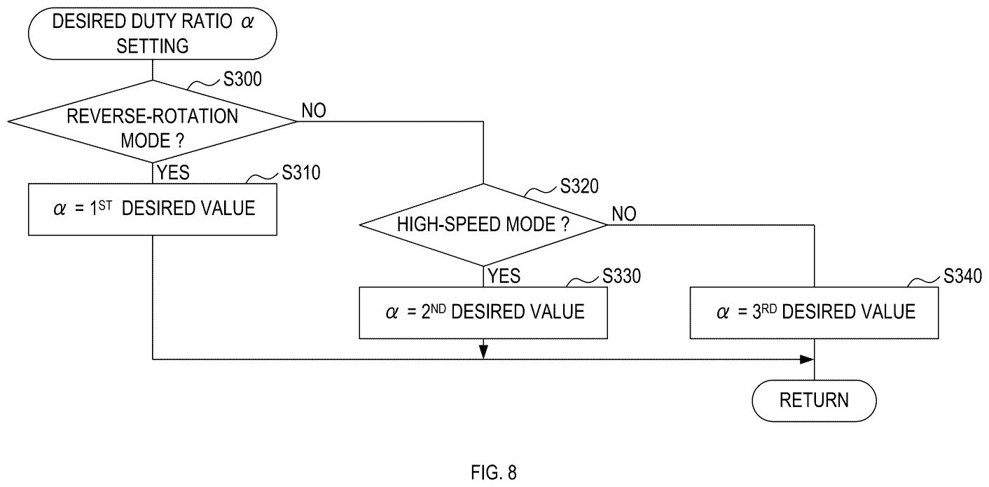

The desired duty ratio α setting process performed by the control circuit 33 in S210 of the output duty ratio setting process will be described with reference to a flowchart of FIG. 8.

In S300, the control circuit 33 determines whether the reverse-rotation mode is set for the drive mode. Upon determining that the reverse-rotation mode is set (S300: YES), the control circuit 33 proceeds to a process of S310. Upon determining that the reverse-rotation mode is not set (S300: NO), the control circuit 33 proceeds to a process of S320.

In S310, the control circuit 33 sets a first desired value corresponding to the reverse-rotation mode for the desired duty ratio α. As shown in FIG. 7B, the desired duty ratio α is set for each drive mode. The first desired value is, for example, 20%. Then, the control circuit 33 terminates this process.

In S320, the control circuit 33 determines whether the high-speed mode is set for the drive mode. Upon determining that the high-speed mode is set (S320: YES), the control circuit 33 proceeds to a process of S330. Upon determining that the high-speed mode is not set (S320: NO), the control circuit 33 proceeds to a process of S340.

In S330, the control circuit 33 sets a second desired value corresponding to the high-speed mode for the desired duty ratio α and terminates this process. The second desired value is, for example, 30%. In a case where the desired rotational speed ωt is great, even if the desired duty ratio α is increased, overshooting of the actual rotational speed is suppressed. Thus, the control circuit 33 sets, for the desired duty ratio α in the high-speed mode, a value greater than the desired duty ratio α in the reverse-rotation mode and the desired duty ratio α in the low-speed mode.

In S340, the control circuit 33 sets a third desired value corresponding to the low-speed mode for the desired duty ratio α and terminates this process. The third desired value is, for example, 25%. The third desired value is less than the second desired value and greater than the first desired value.

### 1-2-5. Rotation Threshold Setting Process

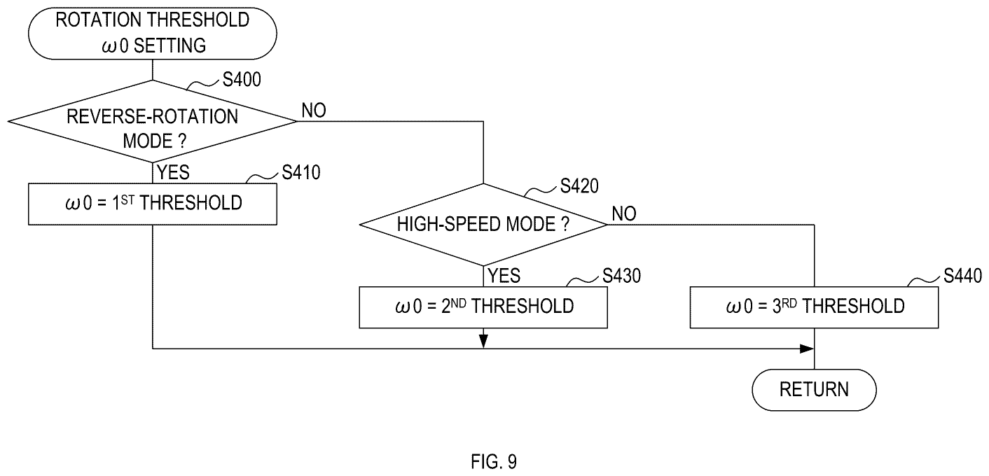

The rotation threshold ω0 setting process performed by the control circuit 33 in S220 of the output duty ratio setting process will be described with reference to a flowchart of FIG. 9.

In S400, the control circuit 33 determines whether the reverse-rotation mode is set for the drive mode. Upon determining that the reverse-rotation mode is set (S400: YES), the control circuit 33 proceeds to a process of S410. Upon determining that the reverse-rotation mode is not set (S400: NO), the control circuit 33 proceeds to a process of S420.

In S410, the control circuit 33 sets a first threshold corresponding to the reverse-rotation mode for the rotation threshold ω0. As shown in FIG. 7A, the rotation threshold ω0 is set for each drive mode. The first threshold is, for example, 600 rpm.

In S420, the control circuit 33 determines whether the high-speed mode is set for the drive mode. Upon determining that the high-speed mode is set (S420: YES), the control circuit 33 proceeds to a process of S430. Upon determining that the high-speed mode is not set (S420: NO), the control circuit 33 proceeds to a process of S440.

In S430, the control circuit 33 sets a second threshold corresponding to the high-speed mode for the rotation threshold ω0 and terminates this process. The second threshold is, for example, 2,000 rpm. In a case where the desired rotational speed ωt is great, even if the rotation threshold ω0 is increased, overshooting of the actual rotational speed is suppressed. Thus, the control circuit 33 sets, for the rotation threshold ω0 in the high-speed mode, a value greater than the rotation threshold ω0 in the reverse-rotation mode and the rotation threshold ω0 in the low-speed mode.

In S440, the control circuit 33 sets a third threshold corresponding to the low-speed mode for the rotation threshold ω0 and terminates this process. The third threshold is, for example, 1,000 rpm. The third threshold is less than the second threshold and greater than the first threshold. In the present embodiment, in every drive mode, the rotation threshold ω0 is set to one-fifth of the desired rotational speed ωt. That is, in every drive mode, the ratio of the rotation threshold ω0 to the desired rotational speed ωt is equal to that in the other drive modes. In other embodiments, the ratio of the rotation threshold ω0 to the desired rotational speed ωt may vary depending on the drive mode.

### 1-2-6. Constant Duty Ratio Control Process

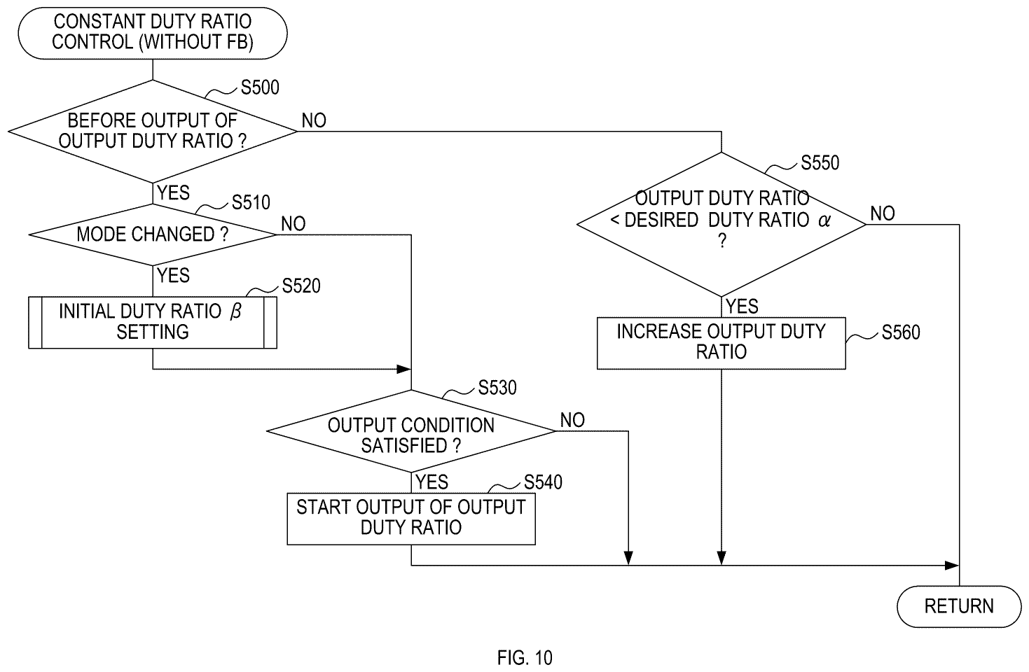

The constant duty ratio control process performed by the control circuit 33 in S250 of the output duty ratio setting process will be described with reference to a flowchart of FIG. 10.

In S500, the control circuit 33 determines whether it is before output of the PWM signal having the output duty ratio. Upon determining that it is before output of the PWM signal (S500: YES), the control circuit 33 proceeds to a process of S510. Upon determining that it is after output of the PWM signal (S500: NO), the control circuit 33 proceeds to a process of S550.

In S510, the control circuit 33 determines whether the set drive mode has changed from the drive mode at the previous process cycle. Upon determining that the drive mode has changed (S510: YES), the control circuit 33 proceeds to a process of S520. Upon determining that the drive mode has not changed (S510: NO), the control circuit 33 proceeds to a process of S530.

In S520, the control circuit 33 performs an initial duty ratio setting process, thus setting an initial duty ratio β as an initial value of the output duty ratio. Then, the control circuit 33 proceeds to a process of S530. The details of the initial duty ratio setting process will be described below.

In S530, the control circuit 33 determines whether an output condition for the PWM signal is satisfied. If the drive permission is set, the control circuit 33 determines that the output condition is satisfied (S530: YES) and proceeds to a process of S540. If the drive permission is not set, the control circuit 33 determines that the output condition is not satisfied (S530: NO) and terminates this process.

In S540, the control circuit 33 starts to output the PWM signal having the set output duty ratio to the gate circuit 34. Then, the control circuit 33 terminates this process.

In S550, the control circuit 33 determines whether the set output duty ratio is less than the desired duty ratio α. Upon determining that the output duty ratio is less than the desired duty ratio α (S550: YES), the control circuit 33 proceeds to a process of S560. Upon determining that the output duty ratio is equal to or greater than the desired duty ratio α (S550: NO), the control circuit 33 terminates this process.

In S560, the control circuit 33 increases the output duty ratio and terminates this process. For example, the control circuit 33 updates the output duty ratio by adding a constant increment value set in advance to the output duty ratio. The increment value is a positive value. Accordingly, the output duty ratio gradually increases at the first increase rate. This, in turn, results in gradually increasing the magnitude of the voltage to be applied to the motor 20 at the first increase rate.

### 1-2-7. Constant Rotation Control Process

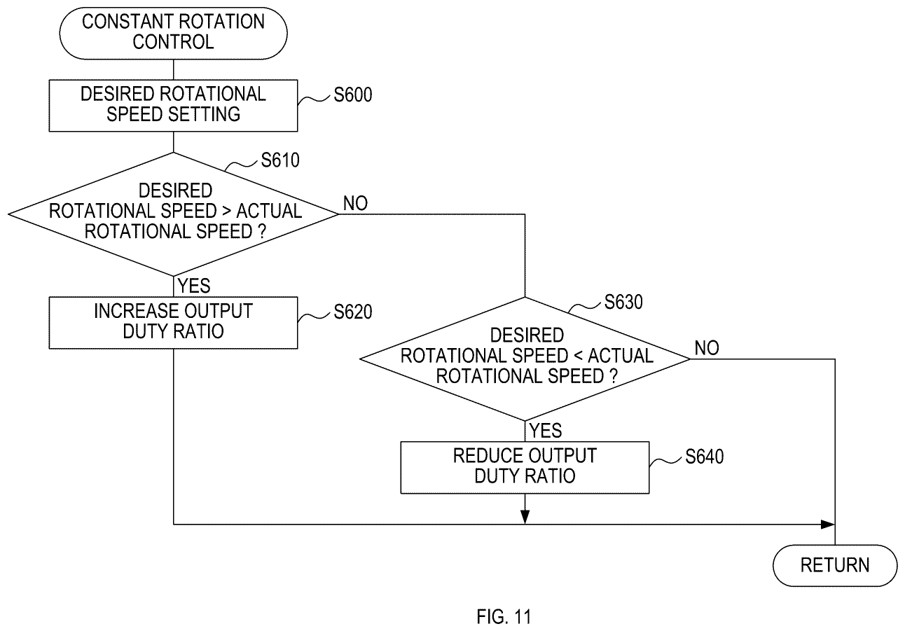

The constant rotation control process performed by the control circuit 33 in S270 of the output duty ratio setting process will be described with reference to a flowchart of FIG. 11.

In S600, the control circuit 33 performs a desired rotational speed setting process, thus setting the desired rotational speed ωt in the constant rotation control. In the constant rotation control, the control circuit 33 maintains the actual rotational speed at the desired rotational speed ωt. The details of the desired rotational speed setting process will be described below.

Then, in S610, the control circuit 33 determines whether the set desired rotational speed ωt is greater than the actual rotational speed calculated in S100. Upon determining that the desired rotational speed ωt is greater than the actual rotational speed (S610: YES), the control circuit 33 proceeds to a process of S620. Upon determining that the desired rotational speed ωt is equal to or less than the actual rotational speed (S610: NO), the control circuit 33 proceeds to a process of S630.

In S620, in order to bring the actual rotational speed closer to the desired rotational speed ωt, the control circuit 33 increases the output duty ratio, thus increasing the actual rotational speed. For example, the control circuit 33 updates the output duty ratio by adding a constant increment value to the output duty ratio. The increment value in S620 may be the same as or different from the increment value in S560. Then, the control circuit 33 terminates this process.

In S630, the control circuit 33 determines whether the actual rotational speed is greater than the desired rotational speed ωt. Upon determining that the actual rotational speed is greater than the desired rotational speed ωt (S630: YES), the control circuit 33 proceeds to a process of S640. Upon determining that the actual rotational speed is equal to the desired rotational speed ωt (S630: NO), the control circuit 33 terminates this process.

In S640, in order to bring the actual rotational speed closer to the desired rotational speed ωt, the control circuit 33 reduces the output duty ratio, thus reducing the actual rotational speed. For example, the control circuit 33 updates the output duty ratio by subtracting a constant decrement value set in advance from the output duty ratio. The decrement value is a positive value. Then, the control circuit 33 terminates this process.

### 1-2-8. Initial Duty Ratio Setting Process

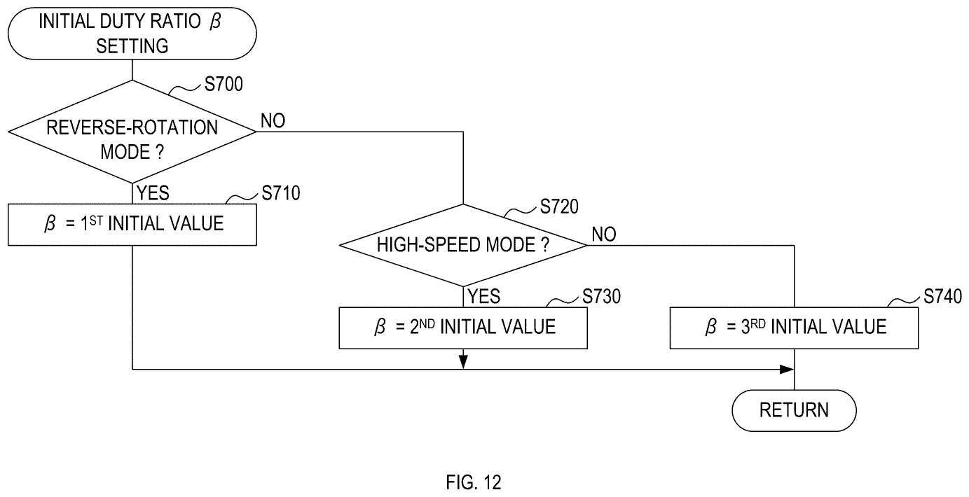

The initial duty ratio β setting process performed by the control circuit 33 in S520 of the constant duty ratio setting process will be described with reference to a flowchart of FIG. 12.

In S700, the control circuit 33 determines whether the reverse-rotation mode is set for the drive mode. Upon determining that the reverse-rotation mode is set (S700: YES), the control circuit 33 proceeds to a process of S710. Upon determining that the reverse-rotation mode is not set (S700: NO), the control circuit 33 proceeds to a process of S720.

In S710, the control circuit 33 sets a first initial value corresponding to the reverse-rotation mode for the initial duty ratio β and terminates this process. As shown in FIG. 7B, the initial duty ratio β is set for each drive mode. The first initial value is, for example, 3%. If the initial duty ratio β is set to 0%, the period of time required until the motor 20 starts rotation increases. Thus, the control circuit 33 sets a value greater than 0% for the initial duty ratio β.

In S720, the control circuit 33 determines whether the high-speed mode is set for the drive mode. Upon determining that the high-speed mode is set (S720: YES), the control circuit 33 proceeds to a process of S730. Upon determining that the high-speed mode is not set (S720: NO), the control circuit 33 proceeds to a process of S740.

In S730, the control circuit 33 sets a second initial value corresponding to the high-speed mode for the initial duty ratio β and terminates this process. The second initial value is, for example, 10%. In a case where the desired rotational speed ωt is great, even if the initial duty ratio β is increased, overshooting of the actual rotational speed is suppressed. Thus, the control circuit 33 sets, for the initial duty ratio β in the high-speed mode, a value greater than the initial duty ratio β in the reverse-rotation mode and the initial duty ratio β in the low-speed mode.

In S740, the control circuit 33 sets a third initial value corresponding to the low-speed mode for the initial duty ratio β and terminates this process. The third initial value is, for example, 5%. The third initial value is less than the second initial value and greater than the first initial value.

### 1-2-9. Desired Rotational Speed Setting Process

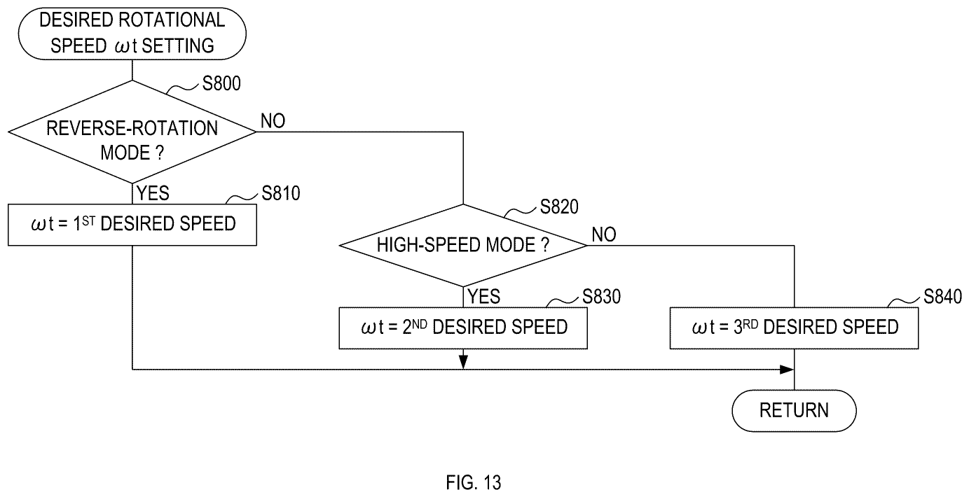

The desired rotational speed setting process performed by the control circuit 33 in S600 of the constant rotation setting process will be described with reference to a flowchart of FIG. 13.

In S800, the control circuit 33 determines whether the reverse-rotation mode is set for the drive mode. Upon determining that the reverse-rotation mode is set (S800: YES), the control circuit 33 proceeds to a process of S810. Upon determining that the reverse-rotation mode is not set (S800: NO), the control circuit 33 proceeds to a process of S820.

In S810, the control circuit 33 sets a first desired speed corresponding to the reverse-rotation mode for the desired rotational speed ωt and terminates this process. As shown in FIG. 7A, the desired rotational speed ωt is set for each drive mode. The first desired speed is, for example, 3,000 rpm.

In S820, the control circuit 33 determines whether the high-speed mode is set for the drive mode. Upon determining that the high-speed mode is set (S820: YES), the control circuit 33 proceeds to a process of S830. Upon determining that the high-speed mode is not set (S820: NO), the control circuit 33 proceeds to a process of S840.

In S830, the control circuit 33 sets a second desired speed corresponding to the high-speed mode for the desired rotational speed ωt and terminates this process. The second desired speed is, for example, 10,000 rpm.

In S840, the control circuit 33 sets a third desired speed corresponding to the low-speed mode for the desired rotational speed ωt and terminates this process. The third desired speed is, for example, 5,000 rpm. The third desired speed is less than the second desired speed and greater than the first desired speed.

### 1-3. Operation

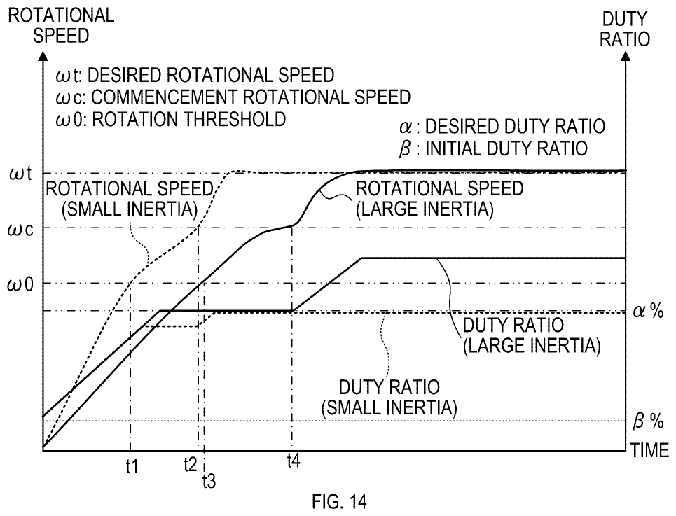

FIG. 14 shows time variation of the actual rotational speed and the output duty ratio in each of the electric work machine 1 with small inertia and the electric work machine 1 with large inertia in the case of performing the output duty ratio setting process of the first embodiment. For the electric work machine 1 with small inertia and the electric work machine 1 with large inertia, the same drive mode is set. Hereinafter, the electric work machine 1 with small inertia is referred to as a first electric work machine 1, and the electric work machine 1 with large inertia is referred to as a second electric work machine 1.

The output duty ratio in the first electric work machine 1 increases at the first increase rate. Then, at a time point t1, the actual rotational speed in the first electric work machine 1 reaches the rotation threshold ω0, and the output duty ratio in the first electric work machine 1 is fixed at a value at the time point t1. Subsequently, at a time point t2, the actual rotational speed in the first electric work machine 1 reaches the commencement rotational speed ωc, and the constant rotation control in the first electric work machine 1 is commenced. In response to the output duty ratio in the first electric work machine 1 being fixed at the value at the time point t1, the increase rate of the actual rotational speed in the first electric work machine 1 during a period between the time points t1 and t2 decreases. Then, from the time point t2 onwards, the actual rotational speed in the first electric work machine 1 is maintained at the desired rotational speed ωt without exceeding the desired rotational speed ωt.

After increasing at the first increase rate, the output duty ratio in the second electric work machine 1 becomes constant at the desired duty ratio α. Then, at a time point t3, the actual rotational speed in the second electric work machine 1 reaches the rotation threshold ω0, and the output duty ratio in the second electric work machine 1 is fixed at a value at the time point t3, that is, to the desired duty ratio α. Subsequently, at a time point t4, the actual rotational speed in the second electric work machine 1 reaches the commencement rotational speed ωc, and the constant rotation control in the second electric work machine 1 is commenced. From the time point t4 onwards, the actual rotational speed in the second electric work machine 1 is maintained at the desired rotational speed ωt without exceeding the desired rotational speed ωt.

In either of the first electric work machine 1 and the second electric work machine 1, overshooting of the actual rotational speed is suppressed. Moreover, a difference between the start-up period in the first electric work machine 1 and the start-up period in the second electric work machine 1, t4-t2, is small. That is, variation in the start-up period due to a difference in inertia is reduced as well.

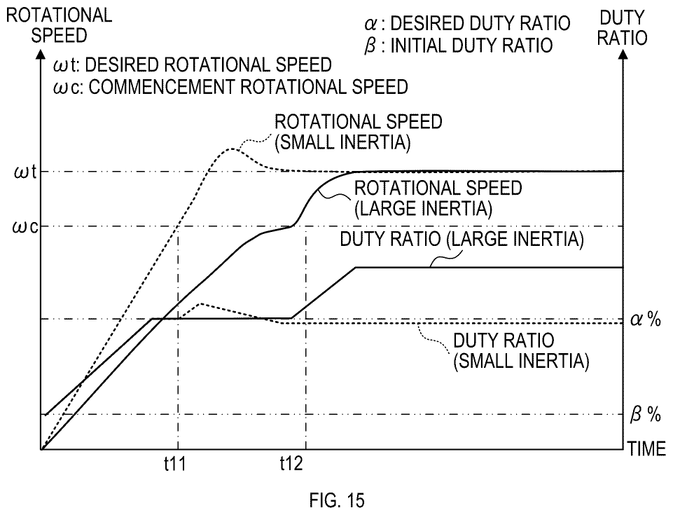

FIG. 15 shows time variation of the actual rotational speed and the output duty ratio in each of an electric work machine with small inertia and an electric work machine with large inertia of a first reference example. Hereinafter, the electric work machine with small inertia of the first reference example is referred to as a third electric work machine, and the electric work machine with large inertia of the first reference example is referred to as a fourth electric work machine. For the third and fourth electric work machines, the same drive mode is set. In the first reference example, the output duty ratio in each of the third and fourth electric work machines is increased at the first increase rate until the actual rotational speed in each of the third and fourth electric work machines, respectively, reaches the commencement rotational speed ωc.

The output duty ratio in the third electric work machine increases at the first increase rate. Then, at a time point t11, the actual rotational speed in the third electric work machine reaches the commencement rotational speed ωc, and the constant rotation control in the third electric work machine is commenced. From the time point t11 onwards, the actual rotational speed in the third electric work machine once becomes greater than the desired rotational speed ωt and then is maintained at the desired rotational speed ωt.

The output duty ratio in the fourth electric work machine increases at the first increase rate. Then, at a time point t12, the actual rotational speed in the fourth electric work machine reaches the commencement rotational speed ωc, and the constant rotation control in the fourth electric work machine is commenced. From the time point t12 onwards, the actual rotational speed in the fourth electric work machine is maintained at the desired rotational speed ωt without exceeding the desired rotational speed ωt.

In the first reference example, a difference between the start-up period in the third electric work machine and the start-up period in the fourth electric work machine, t12-t11, is larger. In other words, in the first reference example, variation in the start-up period due to the difference in inertia is greater than in the present embodiment. In the first reference example, the increase rate of the output duty ratio in the third electric work machine is not reduced before the actual rotational speed in the third electric work machine reaches the commencement rotational speed ωc. Thus, the third electric work machine exhibits faster acceleration than the first electric work machine 1 of the present embodiment, and the difference in the start-up period due to the difference in inertia is larger. Moreover, the actual rotational speed in the third electric work machine is overshooting.

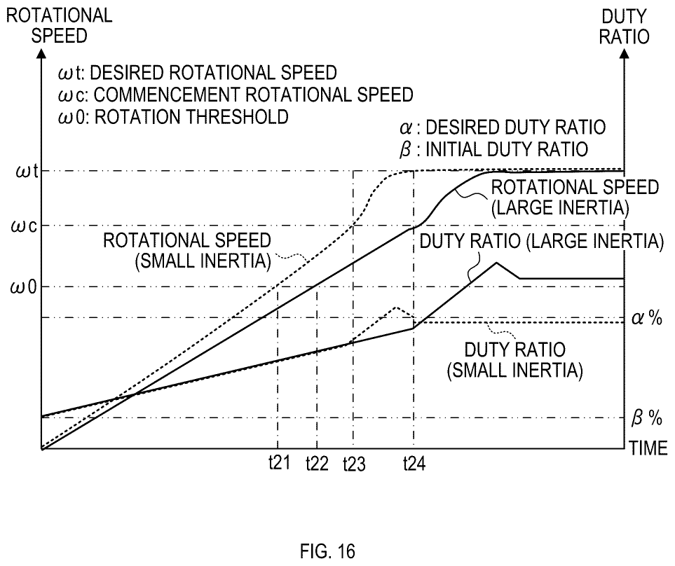

FIG. 16 shows time variation of the actual rotational speed and the output duty ratio in each of an electric work machine with small inertia and an electric work machine with large inertia of a second reference example. Hereinafter, the electric work machine with small inertia of the second reference example is referred to as a fifth electric work machine, and the electric work machine with large inertia of the second reference example is referred to as a sixth electric work machine. For the fifth and sixth electric work machines, the same drive mode is set. In the second reference example, the output duty ratio in each of the fifth and sixth electric work machines is increased at a second increase rate until the actual rotational speed in each of the fifth and sixth electric work machines reaches the commencement rotational speed ωc. The second increase rate is less than the first increase rate.

The output duty ratio in the fifth electric work machine increases at the second increase rate. Then, at a time point t21, the actual rotational speed in the fifth electric work machine reaches the rotation threshold ω0, and the output duty ratio in the fifth electric work machine continues to increase at the second increase rate. Subsequently, at a time point t23, the actual rotational speed in the fifth electric work machine reaches the commencement rotational speed ωc, and the constant rotation control in the fifth electric work machine is commenced. From the time point t23 onwards, the actual rotational speed in the fifth electric work machine is maintained at the desired rotational speed ωt without exceeding the desired rotational speed ωt.

The output duty ratio in the sixth electric work machine increases at the second increase rate. Then, at a time point t22, the actual rotational speed in the sixth electric work machine reaches the rotation threshold ω0, and the output duty ratio in the sixth electric work machine continues to increase at the second increase rate. Subsequently, at a time point t24, the actual rotational speed in the sixth electric work machine reaches the commencement rotational speed ωc, and the constant rotation control in the sixth electric work machine is commenced. From the time point t24 onwards, the actual rotational speed in the sixth electric work machine is maintained at the desired rotational speed ωt without exceeding the desired rotational speed ωt.

In the second reference example, in either case of the fifth and sixth electric work machines, overshooting of the actual rotational speed is suppressed. However, the start-up period of each of the fifth and sixth electric work machines is prolonged. This may impair the usability of users.

### 1-4. Effects

The above-detailed first embodiment produces the following effects:
(1) The increase rate of the output duty ratio is set to zero when the actual rotational speed reaches the rotation threshold ω0. In the case where the inertia of the electric work machine 1 is relatively small, a relatively small fixed value is set for the output duty ratio, thus suppressing overshooting of the actual rotational speed. In the case where the inertia of the electric work machine 1 is relatively large, a relatively large fixed value is set for the output duty ratio, thus reducing an increase in the start-up period. Accordingly, overshooting of the actual rotational speed can be suppressed while reducing variation in the start-up period due to the difference in inertia of the electric work machine 1.
(2) Before the constant rotation control is commenced, the output duty ratio is controlled to be equal to or less than the desired duty ratio α. This makes it possible to inhibit an abrupt increase in the actual rotational speed during the start-up period.
(3) The control circuit 33 commences the constant rotation control before the actual rotational speed reaches the desired rotational speed ωt. This makes it possible to suppress overshooting of the actual rotational speed.
(4) The rotation threshold ω0 is changed depending on whether the drive mode is the high-speed mode or the low-speed mode. This makes it possible to suppress overshooting of the actual rotational speed while reducing variation in the start-up period due to a difference in the drive mode.
(5) The desired duty ratio α is changed depending on whether the drive mode is the high-speed mode or the low-speed mode. This makes it possible to suppress overshooting of the actual rotational speed while reducing variation in the start-up period due to a difference in the drive mode.
(6) The rotation threshold ω0 is changed according to the direction of rotation of the motor 20. This makes it possible to suppress overshooting of the actual rotational speed while reducing variation in the start-up period due to a difference in the direction of rotation.
(7) The desired duty ratio α is changed according to the direction of rotation of the motor 20. This makes it possible to suppress overshooting of the actual rotational speed while reducing variation in the start-up period due to a difference in the direction of rotation.

### 2. Second Embodiment

### 2-1. Differences from First Embodiment

Since a basic configuration of the second embodiment is similar to that of the first embodiment, descriptions will be given below as to differences therebetween. The reference numerals that are the same as those in the first embodiment indicate the same elements, and the preceding descriptions are to be referred to.

In the first embodiment described above, the control circuit 33 fixes the output duty ratio when the actual rotational speed becomes equal to or greater than the rotation threshold ω0 in the start-up period. On the other hand, in the second embodiment, the control circuit 33 changes the increase rate of the output duty ratio from the first increase rate to the second increase rate when the actual rotational speed becomes equal to or greater than the rotation threshold ω0 in the start-up period, which is different from the first embodiment. The second increase rate is greater than 0 and less than the first increase rate.

### 2-2. Output Duty Ratio Setting Process

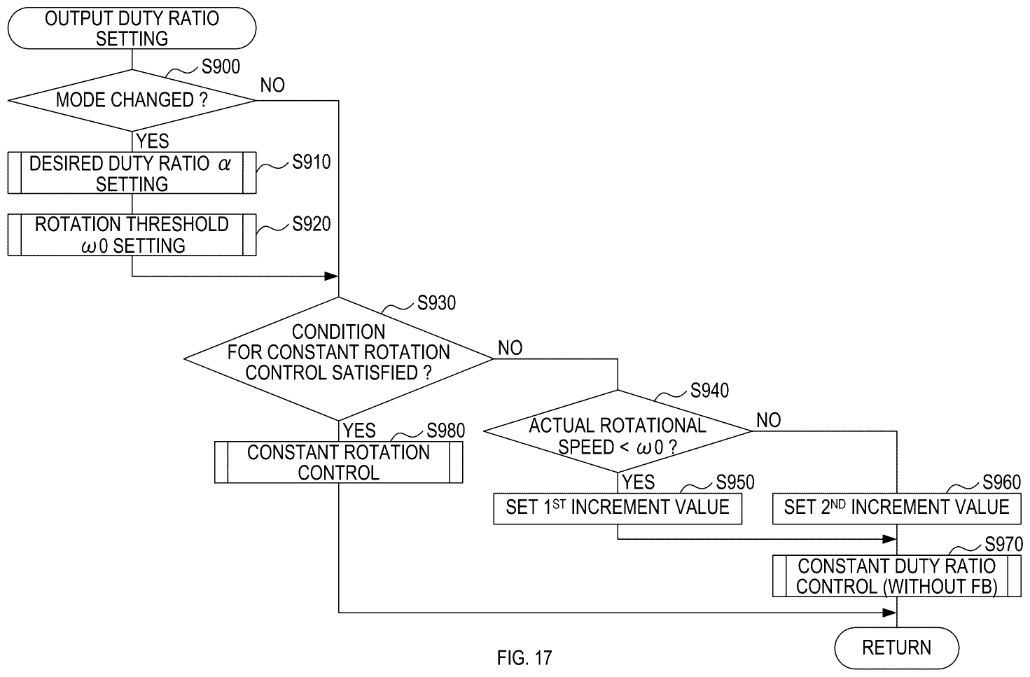

The output duty ratio setting process performed by the control circuit 33 in S130 of the motor control process will be described with reference to a flowchart of FIG. 17.

In S900 to S940, the control circuit 33 performs processes similar to those of S200 to S240, respectively.

In S940, upon determining that the actual rotational speed is less than the rotation threshold ω0 (S940: YES), the control circuit 33 proceeds to a process of S950. In S950, the control circuit 33 sets a first increment value as an increment value for the process of S560 of the constant duty ratio control. The first increment value is equal to the increment value in S560 of the first embodiment and corresponds to the first increase rate. After the process of S950, the control circuit 33 proceeds to a process of S970.

In S940, upon determining that the actual rotational speed is equal to or greater than the rotation threshold ω0 (S940: NO), the control circuit 33 proceeds to a process of S960. In S960, the control circuit 33 sets a second increment value as an increment value for the process of S560 of the constant duty ratio control. The second increment value is less than the first increment value and corresponds to the second increase rate. After the process of S960, the control circuit 33 proceeds to the process of S970.

In S970, the control circuit 33 performs the processes of S500 to S560 of the constant duty ratio control and terminates this process.

In S930, upon determining that the condition for the constant rotation control is satisfied (S930: YES), the control circuit 33 proceeds to a process of S980. In S980, the control circuit 33 performs a process similar to that of S270 and terminates this process.

### 2-3. Operation

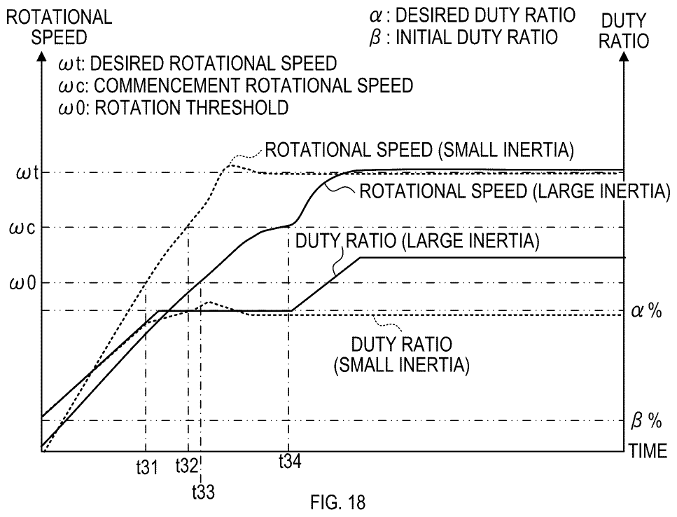

FIG. 18 shows time variation of the actual rotational speed and the output duty ratio in each of the first electric work machine 1 and the second electric work machine 1 in the case of performing the output duty ratio setting process of the second embodiment. For the first electric work machine 1 and the second electric work machine 1, the same drive mode is set.

The output duty ratio in the first electric work machine 1 increases at the first increase rate. Then, at a time point t31, the actual rotational speed in the first electric work machine 1 reaches the rotation threshold ω0, and the increase rate of the output duty ratio in the first electric work machine 1 is changed from the first increase rate to the second increase rate. Subsequently, at a time point t32, the actual rotational speed in the first electric work machine 1 reaches the commencement rotational speed ωc, and the constant rotation control in the first electric work machine 1 is commenced. From the time point t32 onwards, the actual rotational speed in the first electric work machine 1 once becomes greater than the desired rotational speed ωt and then is maintained at the desired rotational speed ωt.

After increasing at the first increase rate, the output duty ratio in the second electric work machine 1 becomes constant at the desired duty ratio α. Then, at a time point t33, the actual rotational speed in the second electric work machine 1 reaches the rotation threshold ω0, and the output duty ratio in the second electric work machine 1 continues to be fixed at the desired duty ratio α. Subsequently, at a time point t34, the actual rotational speed in the second electric work machine 1 reaches the commencement rotational speed ωc, and the constant rotation control in the second electric work machine 1 is commenced. From the time point t34 onwards, the actual rotational speed in the second electric work machine 1 is maintained at the desired rotational speed ωt without exceeding the desired rotational speed ωt.

In the first electric work machine 1, since the increase rate of the output duty ratio is reduced after the actual rotational speed reaches the rotation threshold ω0, overshooting of the actual rotational speed is suppressed. Overshooting of the actual rotational speed is more suppressed than in the first reference example described above. Moreover, a difference between the start-up period in the first electric work machine 1 and the start-up period in the second electric work machine 1, t34-t32, is small. That is, variation in the start-up period due to a difference in inertia is reduced as well.

### 2-3. Effects

The second embodiment detailed above produces the above-described effects (2) to (7) of the first embodiment, and further produces the following effect:
(8) The increase rate of the output duty ratio is reduced from the first increase rate to the second increase rate when the actual rotational speed reaches the rotation threshold ω0. In the case where the inertia of the electric work machine 1 is relatively small, the increase rate of the output duty ratio is reduced relatively early, thus suppressing overshooting of the actual rotational speed. In the case where the inertia of the electric work machine 1 is relatively large, the increase rate of the output duty ratio is reduced relatively late, thus reducing an increase in the start-up period. Accordingly, overshooting of the actual rotational speed can be suppressed while reducing variation in the start-up period due to the difference in inertia of the electric work machine 1.

### 3. Third Embodiment

### 3-1. Differences from First Embodiment

Since a basic configuration of the third embodiment is similar to that of the first embodiment, descriptions will be given below as to differences therebetween. The reference numerals that are the same as those in the first embodiment indicate the same elements, and the preceding descriptions are to be referred to.

In the first embodiment described above, the control circuit 33 sets the fixed value for the output duty ratio regardless of the drive mode when the actual rotational speed becomes equal to or greater than the rotation threshold ω0 in the start-up period. On the other hand, in the third embodiment, the control circuit 33 sets a fixed duty ratio γ according to the drive mode for the output duty ratio when the actual rotational speed becomes equal to or greater than the rotation threshold ω0 in the start-up period, which is different from the first embodiment. The fixed duty ratio γ is equal to or less than the fixed value. Accordingly, in the third embodiment, the output duty ratio may become discontinuous before and after the time point when the actual rotational speed reaches the rotation threshold ω0.

### 3-2. Processes

### 3-2-1. Output Duty Ratio Setting Process

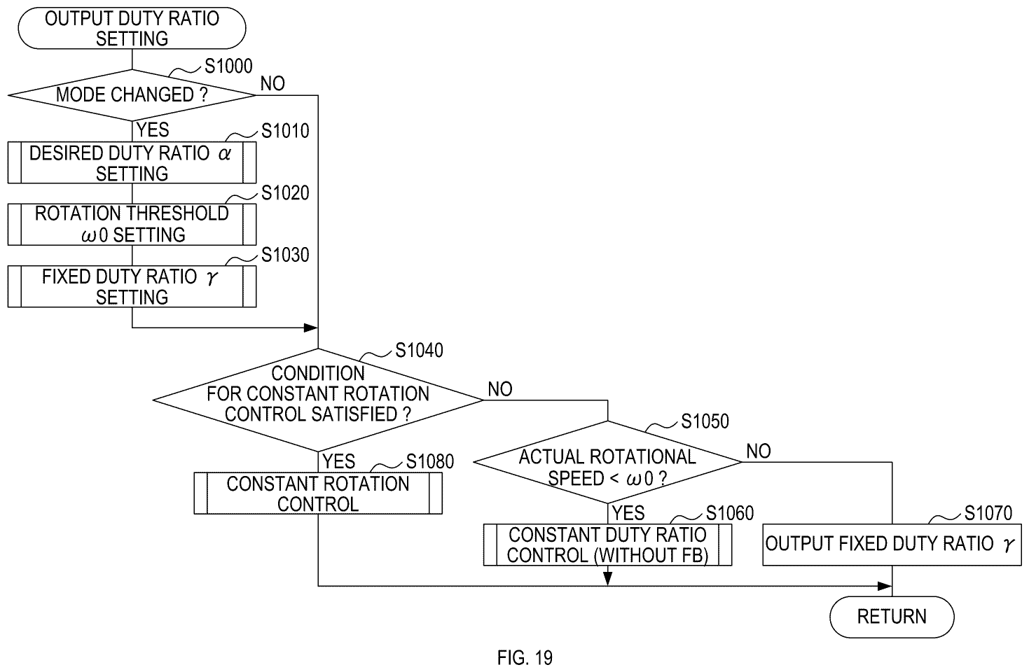

The output duty ratio setting process performed by the control circuit 33 in S130 of the motor control process will be described with reference to a flowchart of FIG. 19.

In S1000 to S1020, the control circuit 33 performs processes similar to those of S200 to S220, respectively.

Then, in S1030, the control circuit 33 performs a fixed duty ratio γ setting process, thus setting the fixed duty ratio γ. The details of the fixed duty ratio γ setting process will be described below.

Subsequently, in S1040 to S1060, the control circuit 33 performs processes similar to those of S230 to S250, respectively.

In S1050, upon determining that the actual rotational speed is equal to or greater than the rotation threshold ω0 (S1050: No), the control circuit 33 proceeds to a process of S1070. In S1070, the control circuit 33 outputs a PWM signal having the fixed duty ratio γ set in S1030 to the gate circuit 34 and terminates this process. In other words, the control circuit 33 fixes the magnitude of the voltage to be applied to the windings 22 to be equal to or less than the value of the applied voltage at the time point when the actual rotational speed reaches the rotation threshold ω0.

In S1040, upon determining that the condition for the constant rotation control is satisfied (S1040: YES), the control circuit 33 proceeds to a process of S1080. In S1080, the control circuit 33 performs a process similar to that of S270 and terminates this process.

### 3-2-2. Fixed Duty Ratio Setting Process

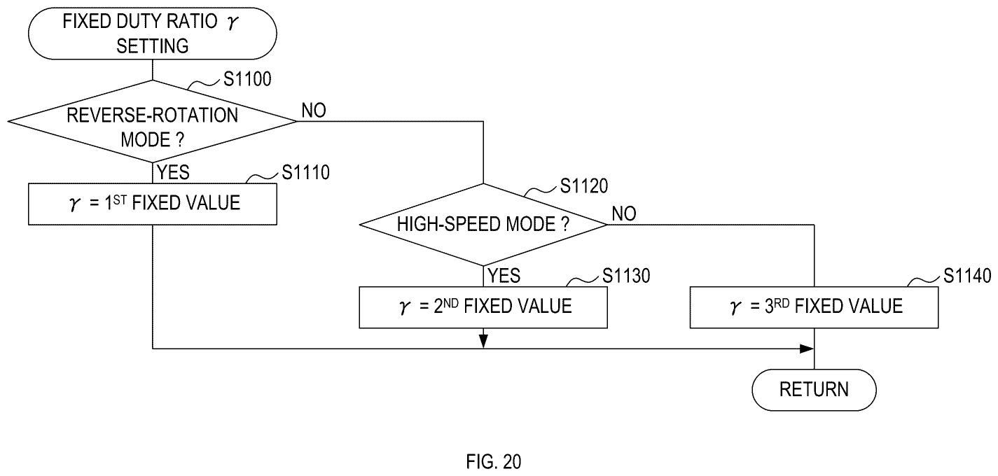

The fixed duty ratio γ setting process performed by the control circuit 33 in S1030 of the output duty ratio setting process will be described with reference to a flowchart of FIG. 20.

In S1100, the control circuit 33 determines whether the reverse-rotation mode is set for the drive mode. Upon determining that the reverse-rotation mode is set (S1100: YES), the control circuit 33 proceeds to a process of S1110. Upon determining that the reverse-rotation mode is not set (S1100: NO), the control circuit 33 proceeds to a process of S1120.

In S1110, the control circuit 33 sets a first fixed value corresponding to the reverse-rotation mode for the fixed duty ratio γ and terminates this process. As shown in FIG. 7B, the fixed duty ratio γ is set for each drive mode. The first fixed value is, for example, 6%.

In S1120, the control circuit 33 determines whether the high-speed mode is set for the drive mode. Upon determining that the high-speed mode is set (S1120: YES), the control circuit 33 proceeds to a process of S1130. Upon determining that the high-speed mode is not set (S1120: NO), the control circuit 33 proceeds to a process of S1140.

In S1130, the control circuit 33 sets a second fixed value corresponding to the high-speed mode for the fixed duty ratio γ and terminates this process. The second fixed value is, for example, 20%. The rotation threshold ω0 in the high-speed mode is set to a value greater than the rotation threshold ω0 in the reverse-rotation mode and the rotation threshold ω0 in the low-speed mode. Thus, the control circuit 33 sets, for the fixed duty ratio γ in the high-speed mode, a value greater than the fixed duty ratio γ in the reverse-rotation mode and the fixed duty ratio γ in the low-speed mode.

In S1140, the control circuit 33 sets a third fixed value corresponding to the low-speed mode for the fixed duty ratio γ and terminates this process. The third fixed value is, for example, 10%. The third fixed value is less than the second fixed value and greater than the first fixed value.

### 3-3. Operation

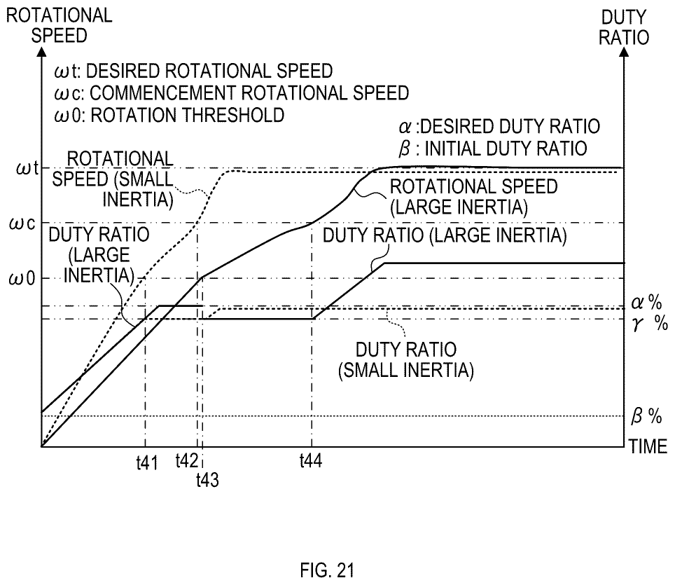

FIG. 21 shows time variation of the actual rotational speed and the output duty ratio of each of the first electric work machine 1 and the second electric work machine 1 in the case of performing the output duty ratio setting process of the third embodiment. For the first electric work machine 1 and the second electric work machine 1, the same drive mode is set.

The output duty ratio in the first electric work machine 1 increases at the first increase rate. Then, at a time point t41, the actual rotational speed in the first electric work machine 1 reaches the rotation threshold ω0, and the fixed duty ratio γ is set for the output duty ratio in the first electric work machine 1. Subsequently, at a time point t42, the actual rotational speed in the first electric work machine 1 reaches the commencement rotational speed ωc, and the constant rotation control in the first electric work machine 1 is commenced. From the time point t42 onwards, the actual rotational speed in the first electric work machine 1 is maintained at the desired rotational speed ωt without exceeding the desired rotational speed ωt.

After increasing at the first increase rate, the output duty ratio in the second electric work machine 1 becomes constant at the desired duty ratio α. Then, at a time point t43, the actual rotational speed in the second electric work machine 1 reaches the rotation threshold ω0, and the fixed duty ratio γ, which is less than the desired duty ratio α, is fixed for the output duty ratio in the second electric work machine 1. Subsequently, at a time point t44, the actual rotational speed in the second electric work machine 1 reaches the commencement rotational speed ωc, and the constant rotation control in the second electric work machine 1 is commenced. From the time point t44 onwards, the actual rotational speed in the second electric work machine 1 is maintained at the desired rotational speed ωt without exceeding the desired rotational speed ωt.

In the present embodiment, the fixed duty ratio γ independent of the difference in inertia is set for the output duty ratio at the time point when the actual rotational speed reaches the rotation threshold ω0. Thus, the difference between the start-up period in the first electric work machine 1 and the start-up period in the second electric work machine 1, t44-t42, is a little larger than in the first embodiment. Accordingly, variation in the start-up period due to the difference in inertia is larger than in the first embodiment. However, the start-up period is shorter than in the second reference example described above. Moreover, in either case of the first electric work machine 1 and the second electric work machine 1, overshooting of the actual rotational speed is suppressed.

### 3-4. Effects

The third embodiment detailed above produces the above-described effects (2) to (7) of the first embodiment, and further produces the following effect:
(9) The fixed duty ratio γ is set for the output duty ratio when the actual rotational speed reaches the rotation threshold ω0. In the case where the inertia of the electric work machine 1 is relatively small, the output duty ratio is fixed at γ relatively early, thus suppressing overshooting of the actual rotational speed. In the case where the inertia of the electric work machine 1 is relatively large, the output duty ratio is fixed at γ relatively late, thus reducing the increase in the start-up period. Accordingly, overshooting of the actual rotational speed can be suppressed while reducing variation in the start-up period due to the difference in inertia of the electric work machine 1.

### 4. Other Embodiments

Although the embodiments have been described so far, the features described in Overview of Embodiments are not limited to the above-described embodiments and can be implemented in variously modified forms.
(a) In the embodiments described above, the electric work machine 1 does not include a position sensor that detects the position of the rotor 21; however, the electric work machine 1 may include the position sensor that detects the position of the rotor 21. The control circuit 33 may calculate the actual rotational speed of the motor 20 based on a signal on the position detected by the position sensor.
(b) In the embodiments described above, the controller 30 includes the control circuit 33; however, in place of or in addition to the control circuit 33, the controller 30 may include a combination of separate electronic components of various kinds, may include an application specified integrated circuit (ASIC), may include an application specific standard product (ASSP), may include a programmable logic device such as a field programmable gate array (FPGA), for example, or may include any combination thereof.

1. An electric work machine comprising:
a motor configured to generate a driving force for rotating a tip tool;
a drive switch configured to be operated by a user to drive the motor; and
a controller configured to:
increase a magnitude of a voltage to be applied to the motor, based on the drive switch being turned on,
reduce an increase in the magnitude of the voltage to be applied, based on an actual rotational speed of the motor having reached a rotation threshold that has been set, and
commence a constant rotation control of the motor before the actual rotational speed reaches a desired rotational speed, thus maintaining the actual rotational speed at the desired rotational speed, the desired rotational speed being greater than the rotation threshold.

2. The electric work machine according to claim 1,
wherein the controller is configured to:
increase the magnitude of the voltage to be applied at a first increase rate, based on the drive switch being turned on, and
change the first increase rate to a second increase rate based on the actual rotational speed having reached the rotation threshold, the second increase rate being less than the first increase rate.

3. The electric work machine according to claim 1,
wherein the controller is configured to:
increase the magnitude of the voltage to be applied at a specified increase rate, based on the drive switch being turned on, and
fix the magnitude of the voltage to be applied at a specified value, based on the actual rotational speed having reached the rotation threshold, the specified value being equal to or less than a magnitude of an applied voltage at a time point when the actual rotational speed reaches the rotation threshold.

4. The electric work machine according to claim 2,
wherein the second increase rate is zero,
wherein the controller is configured to fix the magnitude of the voltage to be applied at a specified value during a period from when the actual rotational speed reaches the rotation threshold until the constant rotation control is commenced, and
wherein the specified value is a magnitude of an applied voltage at a time point when the actual rotational speed reaches the rotation threshold.

5. The electric work machine according to claim 1, further comprising a drive circuit configured to drive the motor,
wherein the controller is configured to:
change the magnitude of the voltage to be applied, based on an output duty ratio of a pulse-width modulation signal to be output to the drive circuit, and
control the output duty ratio to be equal to or less than a desired duty ratio that has been set, during a period from when the drive switch is turned on until the constant rotation control is commenced.

6. The electric work machine according to claim 1,
wherein the controller is configured to commence the constant rotation control based on the actual rotational speed having reached a commencement rotational speed, and
wherein the commencement rotational speed is greater than the rotation threshold and less than the desired rotational speed.

7. The electric work machine according to claim 1,
wherein a drive mode of the motor includes a first mode and a second mode, wherein the electric work machine further comprises a selector switch configured to be operated by the user to select the first mode or the second mode, and
wherein the controller is configured to:
set a first threshold for the rotation threshold based on the first mode being selected via the selector switch, and
set a second threshold for the rotation threshold based on the second mode being selected via the selector switch, the second threshold being different from the first threshold.

8. The electric work machine according to claim 5,
wherein a drive mode of the motor includes a first mode and a second mode, wherein the electric work machine further comprises a selector switch configured to be operated by the user to select the first mode or the second mode, and
wherein the controller is configured to:
set a first duty ratio for the desired duty ratio based on the first mode being selected via the selector switch, and
set a second duty ratio for the desired duty ratio based on the second mode being selected via the selector switch, the second duty ratio being different from the first duty ratio.

9. The electric work machine according to claim 1,
wherein the controller is configured to:
set a third threshold for the rotation threshold based on the motor rotating in a forward direction, and
set a fourth threshold for the rotation threshold based on the motor rotating in a direction opposite to the forward direction, the fourth threshold being different from the third threshold.

10. The electric work machine according to claim 5,
wherein the controller is configured to:
set a third duty ratio for the desired duty ratio based on the motor rotating in a forward direction, and
set a fourth duty ratio for the desired duty ratio based on the motor rotating in a direction opposite to the forward direction, the fourth duty ratio being different from the third duty ratio.

11. A method for controlling a motor of an electric work machine, the method comprising:
increasing a magnitude of a voltage to be applied to the motor, based on a drive switch of the electric work machine being turned on;
reducing an increase in the magnitude of the voltage to be applied, based on an actual rotational speed of the motor having reached a rotation threshold that has been set; and
commencing a constant rotation control of the motor before the actual rotational speed reaches a desired rotational speed, thus maintaining the actual rotational speed at the desired rotational speed, the desired rotational speed being greater than the rotation threshold.
